(19) United States
(12) Patent Application Publication
(10) Pub. No.: US 2015/0234813 A1
(43) Pub. Date: Aug. 20, 2015

(54) Systems and Methods for Categorizing and Accessing Information Databases and for Displaying Query Results

(71) Applicants: Michael R. Knapp, Bainbridge Island, WA (US); Michael Huffman, Eden, NC (US)

(72) Inventors: Michael R. Knapp, Bainbridge Island, WA (US); Michael Huffman, Eden, NC (US)

(21) Appl. No.: 14/530,998

(22) Filed: Nov. 3, 2014

Related U.S. Application Data
(60) Provisional application No. 61/899,863, filed on Nov. 4, 2013.

(51) Int. Cl. G06F 17/30; G06Q 30/02

(52) U.S. Cl. CPC G06F 17/301; G06Q 30/0277; G06F 17/30864; G06F 17/30554

(57) ABSTRACT

Methods, systems, and associated components for the enhanced categorization, accessing and display of information stored in a computer database. The invention provides databases that comprise information components or content that is annotated with descriptive reference components or tags in order to provide a semantic reference to the content. Use of semantic categorization provides databases and the information contained within them to have greater dimensionality and richness which translates to richer queries and query results.

### CROSS-REFERENCE TO RELATED APPLICATIONS

This application claims the benefit of U.S. Provisional Application No. 61/899,863, filed Nov. 4, 2013, which is hereby incorporated by reference in its entirety for all purposes.

### STATEMENT REGARDING FEDERALLY SPONSORED RESEARCH

Not Applicable.

### BACKGROUND OF THE INVENTION

In the early nineties, the internet was heralded as the information super highway. While the ability to communicate, store and access information has increased on a previously unimaginable scale, the full potential of the internet is far from being realized. In at least one respect, the internet has functioned far less like a superhighway upon which information is efficiently conveyed to the waiting masses, and far more like an information dumping ground, in which all of the content is deposited, and the ability to meaningful navigate and access useful information is severely limited as compared to its scale and scope.

Retrieving useful content from this and virtually any other information database has typically involved the development of tools that can survey that database and pull information that may be relevant to the user. Unfortunately, while these tools can be highly effective, they can also suffer from significant shortcomings. For example, because these tools rely upon highly specific key-word based search and retrieval, they will provide results that are very highly focused and specifically responsive to the search query. While this can often be highly useful, any inaccuracy in the search query results in a resulting inaccuracy in the results. Conversely, although delivering responsive, and even accurately responsive search results, these tools will generally fail to provide any dimensionality or generality in its search results. The lack of generality prevents a user from understanding that perhaps, the results they have obtained are either not what the user desired, or will fail to provide the user with optionality in the search results, e.g., the notion that the user may want to explore the related topic field a little more broadly than the original search query was structured to achieve.

It would be advantageous to be able to provide tools for managing information that exists in large caches in a way that allows for greater dimensionality in accessing, categorizing and relating that information. The present invention meets these and other significant needs.

### BRIEF SUMMARY OF THE INVENTION

The invention provides novel and useful methods, systems, and associated components for the enhanced categorization, accessing and display of information stored in a computer database. The invention provides databases that comprise information components or content that is annotated with relational reference components or tags in order to provide a semantic reference to the content. Use of semantic categorization provides databases and the information contained within them to have greater dimensionality and richness, which translates to richer queries and query results.

In some aspects, provided are computer implemented information search systems, that comprise a semantic database comprising a plurality of subjects of interest, each subject of interest being associated with one or more pieces of content of the database, and being related to at least one other subject of interest by one or more semantic tags. Also included is a computer search system coupled to the information database, the search system being programmed to access, identify and display a plurality of related categories based upon a user input search query each of the categories being linked to one or more subjects of interest that share a category defining feature.

Also provided are computer implemented processes for exploring one or more information databases. These processes comprise inputting a search query into a computer search system that is coupled to a first semantic database, the first semantic database comprising a plurality of subjects of interest, each subject of interest being related to at least one other subject of interest by one or more semantic tags. In response to the search query, the computer search system displays a plurality of categories, each of the categories being linked to one or more subjects of interest that share a category defining feature with each other.

In other aspects, provided is a computer user interface, that displays a plurality of information categories, each category defining a plurality of subjects of interest contained within a semantic database, wherein each of the plurality of subjects of interest in each category shares a category defining feature.

In still other aspects, provided is a computer implemented information access process, comprising providing a first database of subjects of interest, each subject of interest being linked to one or more pieces of content within the database by one or more semantic tags. The system compares a search query term to the first database, and identifies subjects of interest in the first database linked to the search query term by one or more semantic tags. The system then presents the subjects of interest of the first database identified in the identifying step.

### BRIEF DESCRIPTION OF THE DRAWINGS

FIG. 1 provides a schematic illustration of varying levels of specificity in tagging of information and how those layers of dimensionality may be used in modulating search results.

FIG. 2 provides a schematic illustration of interrelation of information within a database by virtue of common semantic tag elements.

FIG. 3 shows an exemplary initial search result from a semantic database presented as a list of topics.

FIG. 4 shows an exemplary search result showing a list of semantically related topics to a topic presented in FIG. 3.

FIG. 5 shows an exemplary search result presented as a more focused list of topics based upon the further selection of a semantically related topic from FIG. 3.

FIG. 6 shows an additional exemplary search result presented as a more focused list of topics based upon the further selection of a semantically related topic from FIG. 3.

FIG. 7 shows an additional exemplary search result presented as a more focused list of topics based upon the further selection of a semantically related topic from FIG. 6.

FIG. 8 shows two alternate search paths for reaching the resulting information in the semantic search processes of the invention (panels A and B).

FIG. 9 shows a search output illustrating alternate filtering strategies.

FIG. 10 shows an additional example illustration of search results using different filtering strategies.

### DETAILED DESCRIPTION OF THE INVENTION

### I. Introduction

A. General

The present invention provides a novel approach to accessing, categorizing and relating information within an information database. In particular, what is provided is a semantic categorization of information contained within a database, along with tools that retrieve the information based upon the semantic connection, and then, are able to relate the information through that semantic connection, based upon the user's interest or needs.

In particular, in the context of the invention, information or content within a database is associated with topics or topic names, labels, markers or “tags” (also referred to as “subjects of interest”), that refer to or describe the content within a database. These tags may be highly specific in their relation to or description of the particular database content, or they may be more generic in their reference to or description of the content. In some cases, the tags for content may even provide more abstract references to content. In many preferred aspects, tags associated with a particular piece of content in a database will range from the specific to the generic, and may also include the abstract.

Content within the database may be associated with one or multiple tags or subjects of interest. By providing multiple tags of varying specificity and relation to the content, one can provide a broader spectrum of specificity as to the relation of the tag to the content, as well as provide relation between that piece of content and larger numbers of pieces of content within the database.

In the context of the invention, the subjects of interest or tags may be accessed by their relation to not only the content to which they are immediately associated, but also to those other database components, e.g., other content, other subjects of interest or tags, that share some level of relationship to the tags that are accessed, e.g., are common to multiple pieces of content or are members of common categories of tags or subjects, etc., or combinations of the foregoing. As used herein, the use of tags as relational labels or links between two discrete pieces of content in a database, whether through a single relational element or multiple different relational elements (tags or pieces of content in the database) is referred to as semantic tagging. By providing semantic tagging, one provides greater dimensionality to the information in a database by which the database may be searched. In particular, rather than confining the search-ability of content to the specific elements contained in the content, one can search relevant content based upon its broader meaning or relevance based upon its association with a semantic tag or subject of interest. The system then displays the resulting content and/or subjects of interest based upon their semantic relationships. As such, the systems and processes take user inquiries and transform the input data into displayed lists of semantically related subjects, each of which includes links to semantically related content within the database.

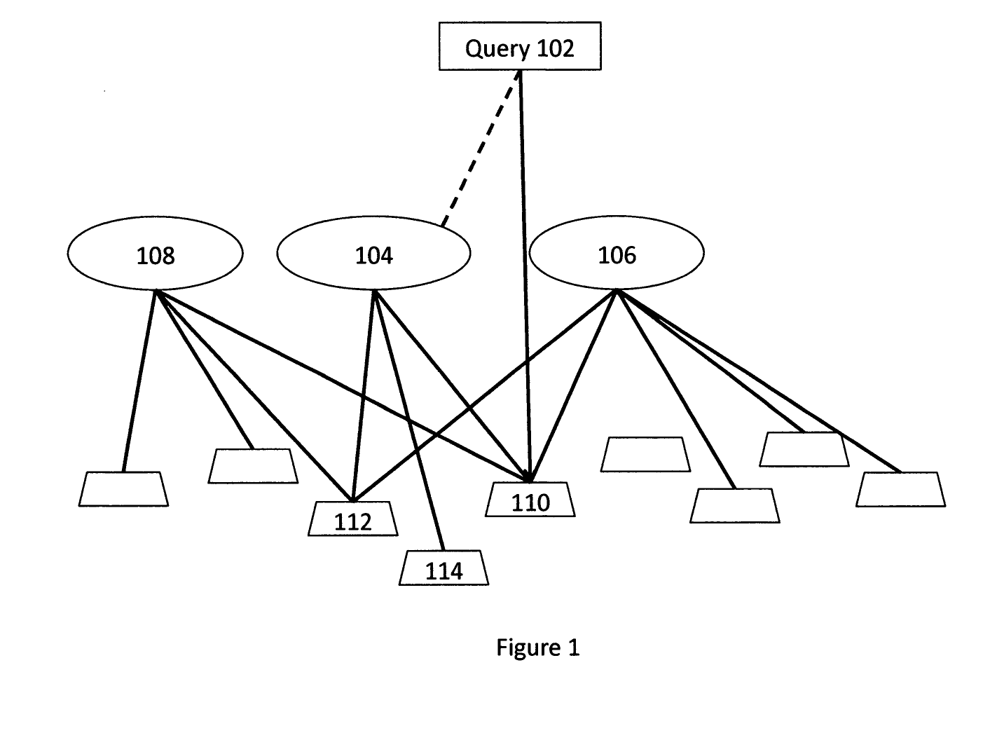

Aspects of the present invention are schematically illustrated with reference to FIG. 1. As shown, a user query 102 is semantically linked to a subject of interest or semantic tag 104 and or 106 within a database. This link may be a result of that tag being associated with a particular piece of content 108 in the database that is directly responsive to the query 102 or based upon a semantic link between the query and the subject of interest (as shown by dashed line). The tools of the invention would then present the user, in response to the query 102, a list of subjects of interest, e.g., subjects 104, 106 and 108 that are semantically related to the query 102 within a defined relational distance of the content 110 (or 112 or 114) or the responsive subject of interest 106, or combinations of these. As will be appreciated, the various illustrated levels may vary, with the content 110-114 referring to a semantic tag or subject of interest within a database, while the higher levels 104, 106 and 108 may represent categories of subjects that each share a category defining feature, e.g., a common semantic relationship that defines a category. Additionally, higher, lower, or intermediate levels of semantic relationships may also be presented. For example, broad categories may optionally be presented as members of even broader classes of categories who share a level of relationship to define a separate class. Likewise, sub-classes, sub-categories, sub-topics or subjects or the like may also optionally be presented.

By way of example, a search query 104 for “Frank Sinatra” might result in the display of categories such as “Members of the Rat Pack” 104, “Famous Italian Americans” 106 and “Crooners” 108, and which also represent semantic categorizations associated with the “Frank Sinatra” query or content 110 related to Frank Sinatra. Selection of any of these presented categories will then result in presentation of other members of that category, e.g., selection of “Members of the Rat Pack” might yield “Dean Martin” 112, who is also a Famous Italian American and a Crooner and thus defined within and tagged by the categories 104, 106 and 108, and “Peter Lawford” 114, who as to the categories listed would only be defined as a “Member of the Rat Pack” under category 104.

B. Information Databases

1. Generally

In general, the categorization and accessing aspects of the invention are applicable to a wide variety of different information databases, from relatively small and localized databases to extremely large and dispersed databases. For example, semantic tagging and searching may be applied to databases stored on a single computer, within a single server system, within the server network of large institutions, or databases distributed over large widely distributed computer networks. Virtually any information database in which content is amenable to semantic reference or taggin, e.g., where interrelated content provides more dimensionality than mere numbers, can be efficiently utilized as a semantically categorized database. As will be appreciated, the more complex the individual pieces of content of a database, the more amenable they will be to multiple layers of semantic reference. As used herein, the content of a database is referred to herein generally as “files”, although this refers not necessarily referring to discrete files, but also to references for where additional content may be accessed within the broader database, e.g., URLs, or other digital references where content may be obtained. In the context of the invention, a semantic search may return results based upon one, two, three, four, five or more different relational elements or steps, e.g., tags, pieces of content etc. The greater the number of intervening relational elements, the more expanded will be the search results.

2. Examples

Particularly exemplary information databases for which the instant invention is applicable, and which illustrate the broad applicability, include everything from a single computer's hard drive, to a single institution's server or server system, to an interconnected server network of a government or collection of institutions, all the way up to the vast content storage available to internet access. Without limiting the breadth of applicability of the invention, the following specific examples are provided in order to better illustrate the applicability of the invention to different types of databases.

In one example, an information database may be as small and insular as a hard drive on a single computer. In particular, as personal computers have become ubiquitously integrated into both work and home life, more and large categories of information are being stored on individual computer hard drives that would benefit from the categorization and accessing tools of the invention. In one particular example, a large photo library of personal pictures taken over the years can amount to very large numbers of files that can be difficult to explore broadly, as they generally require a searcher to scroll through photo after photo in order to find the particular image for which they are searching, or to search a tagged photo library for a precise photo bearing the tag. However, that same photo library, where each file is provided semantically linked or tagged with a broader ontology, e.g., based upon locations, subjects, periods, and the like, may be more easily and broadly explored. By way of example, an ordinary search of a conventionally tagged photo database using, e.g., the search terms “panda” would likely turn up photos tagged with these terms, e.g., a photo of one's daughter at the panda exhibit at a zoo. This result would be to the exclusion of all other photos of your daughter, your other children or relatives, as well as all other zoo animals at the zoo. In a semantically tagged photo database, photos of one's daughter at the Panda Exhibit might be linked with a broader set of subjects of interest, including “family”, “Zoo Animals”, “Daughter”, or the like. A search for “Panda” could then display however, depending upon the scope of the desired search results, search results would provide a broader spectrum of relevant search results, by presenting the searcher with multiple categories of photos that might be of interest to the searcher, including pictures of other pandas, family pictures, pictures of other zoo animals, or pictures of your daughter. As noted elsewhere herein, the scope of the retuned results is optionally within the searchers control.

In a similar fashion, personal music libraries could likewise be categorized and accessed in searching for particular music genres, styles, moods, parties where they were played, or the like, based upon user tagging. As will be appreciated, a search for a given song might present the searcher with the song itself as its own subject of interest, but potentially also with much more, including, for example, the date of a party where the song was played, the guests at the party, or contact information for someone you met at that party or myriad other possible semantically liked pieces of information.

In another specific example, large collections of scientific literature are particularly amenable to categorization and access using the tools described herein. In particular, most scientific literature is searched by keyword based upon the content of articles. However, as repeatedly noted herein, such searching tends to be of low dimensionality and while it may often yield the most relevant references based upon the search query, it lacks the ability to identify peripherally relevant references, which, depending upon the accuracy of the search query, may actually turn out to be more relevant to the desired references. Based upon the substantial diversity of vocabulary specialties/subspecialties in virtually every field of scientific or technical endeavor, such databases are particularly ripe for the use of semantic tagging to provide both characterization or categorization, as well as ability to access relevant references. As will be appreciated, virtually any library database would see similar benefits.

Another highly specific example of an information database that would benefit from the tools of the invention are the large document storage databases of, e.g., law firms and other services industries. With reference to the law firm example, most law firm document storage systems rely upon the use of client and file identifiers as the basis for storing and accessing documentation. While this system is highly effective at organizing each client's documents and files, it can be highly inflexible when one wishes to search across multiple clients and files to identify relevant information to a particular need. For example, attorneys seeking to draft a particular type of agreement that they have not previously drafted may wish to obtain examples of such agreements drafted by other attorneys in the firm. Rather than sending out a request to the law firm's personnel, it would be much more efficient to be able to search the database of relevant documentation to more effectively explore the relevant documents within the law firm's database in order to identify the most relevant examples of such documents based upon the attorney's specific needs. Similarly, in taking on representation of new clients or new matters for existing clients, law firms will often conduct conflict reviews to make sure the proposed representation would not conflict with the representation of other clients. These checks tend to be limited to inquiries sent to attorneys at the firm as well as queries of client databases based upon an input list of potentially conflicting parties. Again, this searching relies heavily upon the error prone input of humans. By accessing the larger document database based upon the more richly defined inter-relation of semantic tags (e.g., naming conflicting parties, subject matter; such as “trade secret theft”, “doctrine of equivalents” or “liquidated damages”, and even legal position, e.g. “strident arguments against patentability of human DNA”), even these routine conflict checks would be more efficient and effective, and would better position the searcher vis a vis the position of the firm and its clients.

Of course, the most relevant example of information databases categorizable and accessible by the tools of the invention would be the distributed information content on the internet. In particular, as discussed in greater detail elsewhere herein, current tools for searching the internet rely upon the identification of the presence of keywords within information content, which is generally followed by ranking the retrieved results based upon relevance that is, itself, based upon the number of times that the particular piece of information turned up in a search. As will be appreciated, while this may be useful for a large number of searches, it ignores that many searches may not be looking for the most popular result of a particular search query, but the most relevant result (as well as highly relevant related results) of the search query. Further, as will be appreciated, the use of popularity as an ordering mechanism of search results is a self-propagating mechanism, resulting in possibly more relevant search results rarely being uncovered.

### II. Information Limited Dimensionality Problem

A. The Problem

Current systems and tools for searching and accessing information from large databases of information suffer from a limited level of dimensionality. In other words, these search systems typically rely on one or a few characteristics of the information, for example, key words that are contained within content being searched. Some search tools try to provide greater depth to information retrieved using this limited dimensional search, e.g., by ranking according to relevance based upon number of key word hits within the content, ranking the pieces of content retrieved by current popularity, suggesting different searches based upon the searching activity of others who retrieved the same information, or the like. Despite this, current searching processes, systems and tools, and as a result, the information they retrieve, is generally lacking in contextual or semantic relevance.

The advantage of contextual or semantic relevance can be illustrated with respect to a simple example: a person sitting in their house hears a barking dog. Within this example, contextual relevance can take on significant importance when, for example, the person hearing the barking dog can associate that information with the information that the dog appears to be the neighbor's dog. Further context allows the relation of the neighbor's dog to the knowledge that this neighbor is out of town. Again, further context may also relate that dogs often bark at burglars, relating that information, in turn, to the information that there have been several recent burglaries in the neighborhood. With all of this context, one is far more likely to be spurred to action in calling the police or at least investigating the cause of the dog's barking.

By comparison, drawing from the same example, but applying a thought process that relied upon more limited dimensionality, such as search popularity, one would be far more likely to end up acting upon a potential approach to get an annoying dog to stop barking.

B. Semantic Categorization

While the foregoing simplified example envisions a human thought process, it is nonetheless illustrative of the problems facing information searching, access, categorization and interrelation within information databases. By relying upon a limited dimensionality of current search tools, information access and retrieval from these databases is far less rich than it could otherwise be. As described herein, however, systems and tools are described for providing information categorization, access, retrieval and presentation based upon a greater semantic and contextual relevance of the information to the searcher's needs than currently exists.

### III. Giving More Dimensionality to Stored Information

The first aspect of the invention relates to providing a greater level of dimensionality to each piece of information or “content” within a database by virtue of its semantic relationship to other content in the database. Rather than simply relying upon actual words that appear within the content, additional characteristics of the content are attached to the content as “tags”. Tags will generally apply an added dimension to the content beyond its keywords. As with the barking dog example above, tags would add dimensionality akin to “neighbor's dog”, “dogs bark at burglars”, “neighbor out of town”, etc.

As a simple example, an article in a database that is about pizza could be tagged with “food”, “dough”, “flour”, “cheese”, “Mozzarella”, “Mozzarella di Bufala”, “tomatoes”, “Naples”, “iconic”, “New York”, “pepperoni”, “Italian cuisine”, and myriad other appropriate tags. Because the semantic tags are connected to content by real world relationships, they can be used to retrieve relevant content, even where that content is tagged with only one or a few tags. Each of these tags would provide a new opportunity to access this content based upon a user's selected search terms or by its relation to other content turned up by the user's search. For example, someone searching for “foods of Naples” could access the article even if it never mentions Naples in the content.

In addition to providing greater accessibility to tagged content, tags also provide components of relation of one piece of content to another. Again, merely by way of example, by virtue of these tags, a search on “New York” would provide articles on the city, but could also be used to provide the user with the opportunity to explore a set of results that are related through the tags associated with that content and other content, such as articles on great pizza recipes or restaurants.

Not only does this relational aspect provide a more comprehensive result of one's search, e.g., by providing multiple highly relevant pieces of content, it can also provide a new level of richness to a search result, by providing the searcher with related subjects or categories of subjects that the searcher may not have thought to look for or even known they might be interested in. In particular although a user may have a reasonably precisely crafted search to identify the content that they believe they need, by providing results that are more broadly related to the crafted search through common semantic tags, the user will be presented with content that can be related to the crafted search at varied levels of relevance, even if the user did not know to search for that content at the outset.

Phrased another way, a typical key word search will provide a vertical targeting of information in a database based upon the content containing those key word searches. Despite actually providing a vertical search result, typical search engines attempt to provide a level of dimensionality through the displaying of popular search results that are turned up along with that same content. However, these search results are based upon popularity of the content from the relevant searching public, rather than actual relation to the discovered content.

In contrast, the systems of the invention provide results that allow better exploration in a non-vertical, or “horizontal” fashion, by displaying intermediate categories that include a plurality of subjects of interest that are responsive to the search query. These categories define groups of subjects of interest that are related to each other within a semantic database, e.g., by possessing common semantic tags, or themselves being semantic tags for common pieces of content or other subjects of interest.

Additionally, the user may be provided with search results that, while not precisely related to their original crafted search, is nonetheless of interest to the searcher, given their established interest in the original crafted search. Furthermore, in certain embodiments, the user may actively select the level of richness of a crafted search in order to increase or decrease the scope of search results. In particular, the searcher may know precisely what they are looking for and be interested in a tightly controlled output of results, while at other times, a searcher may wish to expand the scope of the search results to explore a broader range of content that is, perhaps, more loosely related to the originally crafted search. For example, a searcher may wish to “find” a specific type of content, such as a biography of a specific historical figure. In contrast, in other cases, a searcher may wish to more broadly “explore” a category of information in order to gain knowledge in a broader topic, e.g., accessing information about a certain historical period. In still other approaches, a searcher may wish to “discover” other content that may be related to broad categories, but in less direct fashion, such as celebrities who are also interested in a given historical period, museums with current exhibits on that period, etc.

While generally discussed above as providing a level of inter-relation between pieces of content within a database that are searched using conventional key words, the semantic tags can themselves form the keywords for a user search, thus allowing access to multiple pieces of related information by searching for the basis of their relation.

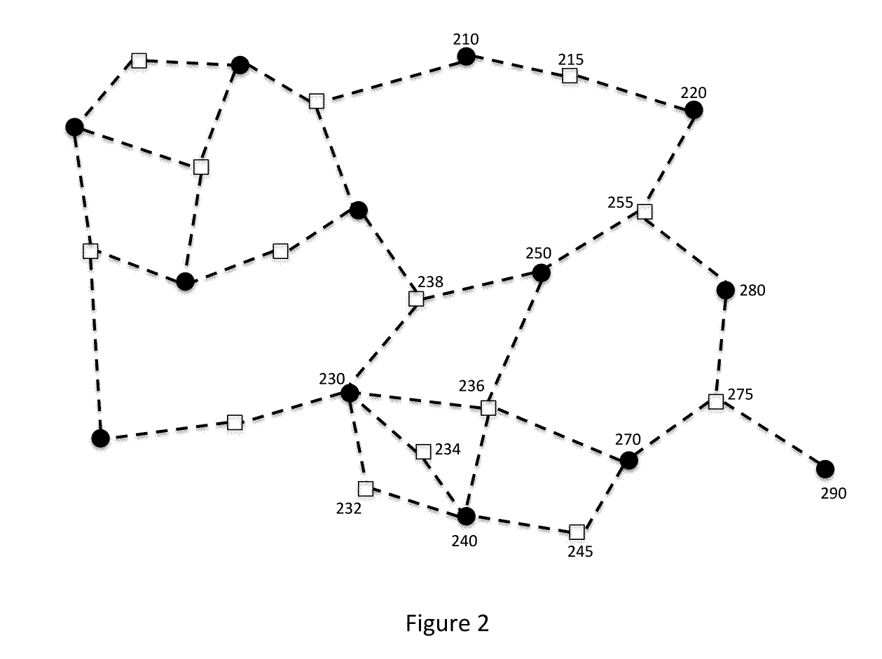

These various aspects of the invention may be schematically illustrated with reference to FIG. 2. As shown, discrete pieces or files of information in the database are illustrated as the filled circles. These pieces of information are provided with associated semantic tags (shown as squares associated to the piece of content by the dashed lines) which may or may not be shared among other pieces of information within the database. By way of illustration, particular information or content forms a node (an “information node”), such as information node 210, that is related to other information nodes, such as information node 220, in the database by the node formed by the semantic tags (“tag nodes”), e.g., tag node 215. Accordingly, with reference to the discussion of FIG. 1, above, a search that produces information node 210 as a relevant hit, would also be capable of presenting information node 220 as related content by virtue of its single node connection to information node 210. Similarly, a search that produces information node 230 would also be able to present information node 240 due to the multiple single node connections they share (tag nodes 232, 234 and 236). Likewise, information node 250 would also be presented based upon the shared tag nodes 238 and 236. Further, the inter relatedness of information nodes 230 to 240 and 250 would be presented with greater confidence based upon such multiple shared tag nodes.

In a further advantage of the invention, in some aspects, users may select the level of inter-relatedness of information, e.g., the number of nodes of separation, depending upon their searching goals, e.g., whether they are looking to “find”, “explore” or “discover”, as discussed above. For example, a searcher seeing to find a particular information node may tailor the search system to yield just the most relevant hit, e.g., information node 230, based upon their search criteria. Another searcher may be seeking to explore the broader relevant category of information related to information node 230, and thus could set the search system to produce information nodes that are connected to information node 230 by only one or two intervening tag and information nodes, e.g., single node connected information nodes 240, 250, or multiple node connected information node 270. In still other aspects, the searcher may wish to expand a search to broadly explore information categories more loosely related to their specific search criteria that is centered around information node 230, and capture information that is more tenuously connected by much larger numbers of nodes, e.g., information nodes 280 and 290 which have three nodes between them and information node 230, or even information node.

A. Information Tagging

As described herein, the tools of the invention rely upon the use of semantic tagging of information content within a database. Tags may generally be provided as associated files with a particular information file within the database. These tag files will generally be small descriptive terms or phrases that refer to the information with which they are associated. As noted, these descriptive terms or phrases may be highly specific or literal references to the information, or they may be more generic or abstract. Further, any given piece of information would be provided with a large and ever expanding number of semantic tags based upon tagging tools and opportunities described in greater detail below. As such, the number of tags shared with other pieces of information content would likewise be potentially large and expanding. These inter-relations form the basis of the richness of search results, as described elsewhere herein, as well as the ability to expand to more distantly related information, e.g., through multiple nodes. Semantic tags may generally be derived from a number of origins. For example, they may be generated from one or more existing ontologies to provide a tagging menu that overlays a database content and can be use to tag content in an inter-relational fashion.

C. Tools for Tagging

In accordance with the invention, tools for providing content with semantic tags which can then be used to categorize and access information are also provided. In a first aspect, the tools may include an API that allows a user to tag content based upon a standardized set of topics. and attach it to a particular piece of information within a database. This may be a broadly dispersed API allowing a large number of users to provide tagging of content. In general, having large numbers of users assist in the tagging process will enhance the richness of the tagging process as it will, as noted above, draw form a broader vocabulary in referencing any individual pieces of informational content. Likewise, the risks of detrimental, irrelevant or mischievous tagging is minimized as such tags would rarely form broader associations, and would be overwhelmed by the proper or relevant tags at an early stage.

Other tools for tagging information may provide a more incentivized approach to obtaining user participation. For example, tags that users associate with personal content, e.g., in their own personal bookmarks, or own stored databases could be applied to larger dispersed databases. For example, using a standard API to categorize ones own information, would allow the searcher to reach out to other databases, in order to identify content related to their own. In performing this exploration, the users own tags would be compared to the tags on the information within the database. Common tags would be used to identify relevant information, while non-overlapping tags would be applied to the information in order to expand the tagging on that information.

Additionally, users could be provided with gaming opportunities to increase the number of tags, as well as node connections within the database.

### IV. Searching Based Upon Greater Dimensionality

A. Generally

As noted above, the enhanced dimensionality of information within a database based upon the presence of semantic tags or references for content within the database may provide multiple advantages in searching processes. First, as noted above, the semantic tags for information provides relationships between multiple pieces of information within the database based upon the descriptive reference of the semantic tag or tags. Further, by identifying pieces of content that share multiple semantic tags a search will be able to present multiple more highly relevant references, despite that such references might not share the common keywords that were the basis of the underlying query.

Further, by providing stepping stones of semantic references among information within the database, the processes of the invention permit the ability to control the level of relation between information presented in search results.

B. Tools for Searching

In accordance with the present invention, tools are provided for searching information databases based upon semantic tagging. In particular, such tools may include search engines that access the tags associated with content instead of or in addition to accessing the information contained within the content. In some cases, these tools may be provided as plug-ins or bookmarklets that operate on conventional web browsers, and provide ordering or prioritization of broader search results based upon the semantic tagging of the recovered information. For example, user tools may include a “personal semantic web” function. While surfing the interne with a conventional browser, a plug-in or bookmarklet allows the URL of an interesting web page to be associated with one, or more, Standardized Topics. Those annotated URLs are uploaded to the database of the invention and now represent “content” that the database can show others who are interested in the same Standard Topics. Each user will have their account page where they can access their own topic-associated URLs, the API navigation menu, and the content related to the URLs they have stored of for example videos, other people's content associated with the same Standard Topics, social media associated with those Topics, etc.

C. User Controllable Degrees of Separation

As described above, one aspect of the searching tools of the invention is to provide a user controllable selection of relatedness for reporting search results. In particular, the tools will provide a selectable relatedness in terms of the number of nodes or degrees of separation for information that is presented depending upon the goals of the searcher. For example, in the particular search API, the user may select the relevance of search results to the query. This selection may allow the input of the number of information and/or tag nodes between the most relevant piece of content and other presented pieces of content. Alternatively, the user may select the broad range of relevance from, e.g., “find” which would be a highly targeted search result presentation, to explore, for a more generalized result presentation, to “discover” which would present results based upon more distant connections.

IV. Presenting Information with Greater Dimensionality

In addition to allowing searches to be carried out with greater dimensionality, in particularly preferred aspects, the systems and processes of the invention allow for the results of those searches to be presented with this added level of dimensionality. In particular, a search result may be presented as a list of subject categories that each define a collection of individual subjects of interest. Each category listed is semantically related to the search query. Further, the subjects of interest within a given category are semantically related to each other, e.g., they share a semantic tag, or define a semantic tag for a common piece of content or other subject. Each subject is then linked to content within a database, either based upon key word relationships, semantically, or both. This list of subject categories would then be accessed by the searcher based upon either their interest in a more specific result, or based upon their desire to explore broadly related topics to the original search.

By way of example, a search query for “elephant” would result in the presentation of a list of categories that are semantically related to “elephant”, e.g., they represent the semantic tags or categorization of elephants within the database. For example, a search for elephant may result in the display of categories semantically related to “elephant” such as “elephants”, “tool using species” and “herbivorous animals”. In addition to including elephants as a subject of interest, each category includes other subjects of interest that are semantically related to elephants by virtue of a category defining feature. For example, the category of “herbivorous animals” includes, in addition to elephants, other herbivorous animals, such as rabbits, giant pandas, giraffes, etc. Each of these subjects is semantically tagged or categorized as an herbivorous animal. Similarly, the category “tool using species”, in addition to elephants, includes other subjects tagged as tool using species, such as humans, otters and the like. Following selection of a category that the user desires to explore further, one is presented with a list of the subjects of interest within that category. The user may then select one or more subjects of interest to explore further. By selecting a desired subject of interest, one may be presented with a further refinement of sub-topics, or in certain aspects, is presented with links to content that is related to the subject of interest, e.g., elephants, giant pandas, or the like.

In further aspects, in addition to providing a list of subject categories related to the search query based upon semantic tagging, the results of a search may optionally be presented with an illustration of the level of relevance. For example, a particular query might identify a handful of content references that are determined to be most highly relevant to the query based upon the relation of the query to the semantic tags on each piece of content. In addition however, the search result would optionally present a second, third or multiple set(s) of references or a link to such sets of references that may be of interest to the searcher, based upon their level of relation to the first category of references. The presented list may optionally be prioritized, or simply listed. Again, if the searcher's query was less accurate, or if the searcher has interest in a broader category, the presented results allow the searcher to access the broader category of relevant information.

In particular, in one aspect, the application of the invention includes a user interface that provides a list of semantic tags, listed as “Topics” to be searched or explored. These tags may be presented upon accessing the application or they may be presented in response to an initial query. By clicking upon one of the Topics or semantic tags, the user is presented with a second list of tags or topics that are semantically related to the first Topic. Clicking upon one of these Topics in the second list then presents a third Topic list that is semantically related to the Topic chosen from the second list. The third Topic list is also semantically related to the first Topic list by virtue of the Topic selected in the second list

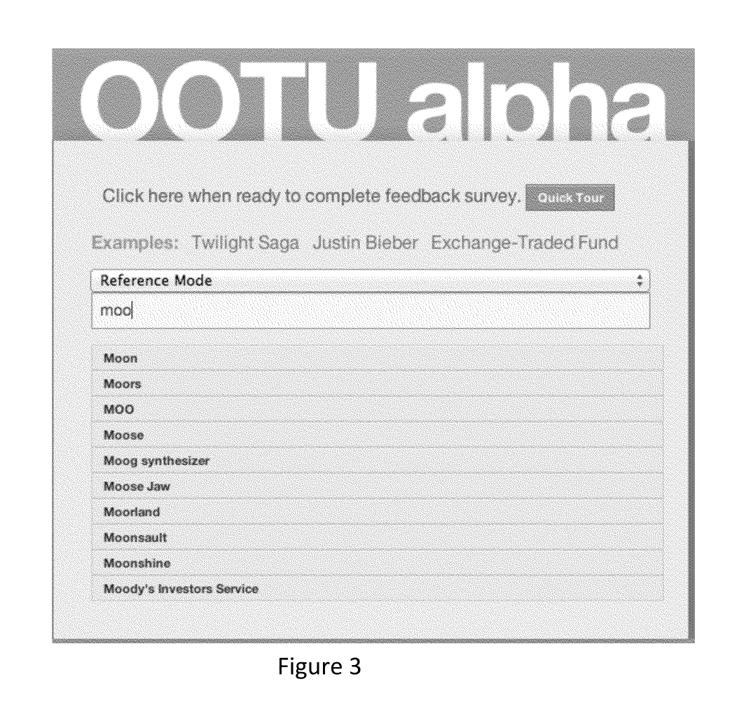

The following example provides an exemplary illustration of the use of the database and searching tools of the invention. In this example, a person interacting with the internet through a browser or an application of the invention, referred to as “OOTU”, starts a search session with a certain topic and seeks information related to that topic. This can be in a quest for specific information or can be driven simply by curiosity, a desire to learn, or a desire to be entertained. The starting point can come by entering a word in a query area of the application. As an example, a user could type the letters m-o-o. In this case, the application suggests topics the user might be interested in that start with those letters, e.g., as shown in FIG. 3.

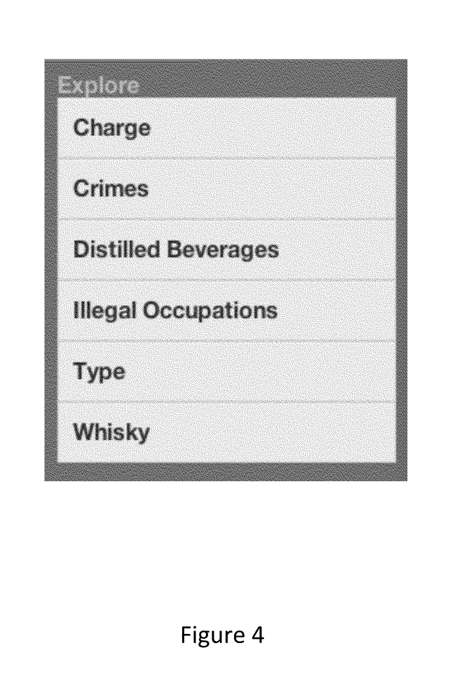

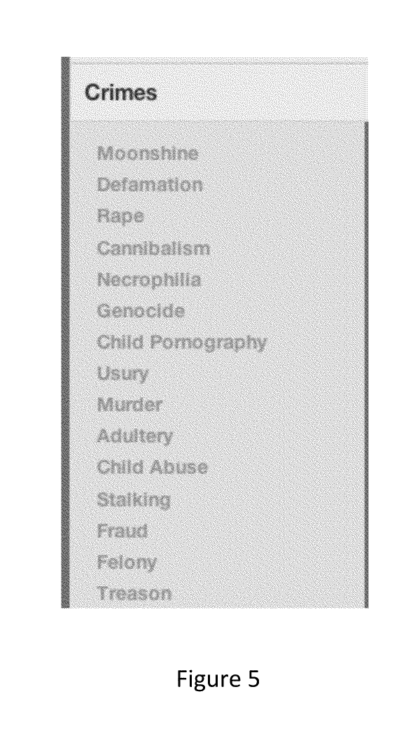

A list of topics is presented that correspond to relationship entities that exist inside the application database, e.g., called “OOTU Topics” in the example presented. These are semantically organized entries, meaning that they are associated with other entries according to relationships that are derived from the conventional meaning of the words. The OOTU Topics can be objects such as “Moon”, a business such as “Moody's Investors Service”, a person, a people such as the “Moors”, an animal such as a “Moose”, a technique (such as the professional wrestling move called a “Moonsault”), etc. If a person looked at this list and were interested in “Moonshine,” they could click on that OOTU Topic offering. The database would then return a list of other database elements that are semantically related to that Topic as shown in FIG. 4. The nature of the relationship can be that the element is a member of a group into which Moonshine falls. For example, making Moonshine is a Crime and an Illegal Occupation. Moonshine is a Distilled Beverage and can be a Whisky. Clicking on the element “Crimes”, as seen in FIG. 5, produces links to other Topics in the OOTU database that are also crimes such as Defamation, Rape, Cannibalism, etc.

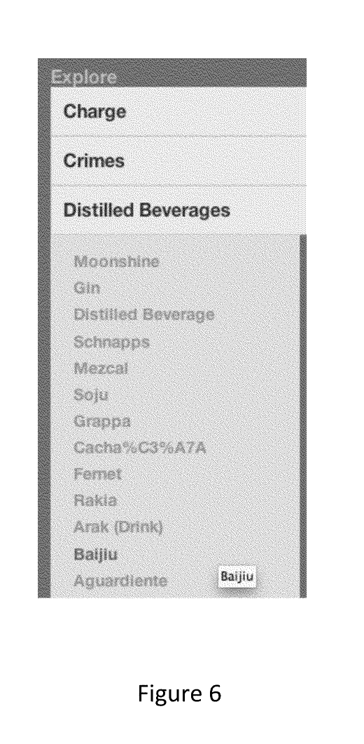

Similarly, expanding the OOTU Category ‘Distilled Beverages’ as in FIG. 6 shows that both Moonshine and Baijiu fall into that category. Thus a relationship is established between Moonshine and Baijiu and a user can investigate the features of Moonshine, but have access to information about the Related Topic of Baijiu through their common category.

Another type of relationship is revealed by the OOTU Topic ‘Charge’, an element of the Explore Topics for ‘Moonshine’. The mobster Sam Giancana is listed under ‘Charge’ because it is one of the crimes that he was charged with. It is therefore an attribute of Sam Giancana. A user can click on his name as an OOTU Topic and be taken to his entry.

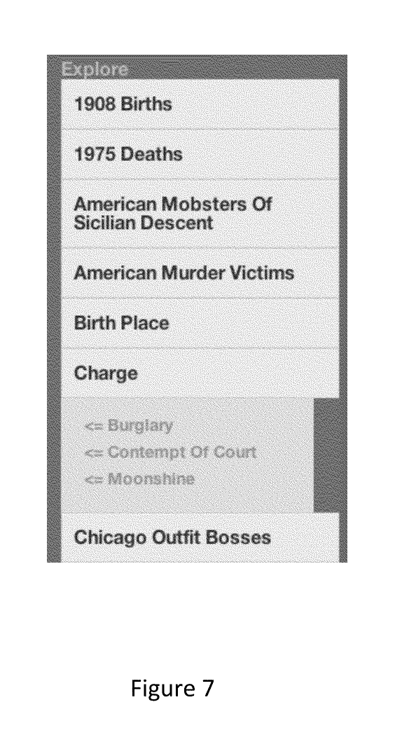

As shown in FIG. 7, one can see other crimes with which he was charged because his entry is connected to other OOTU Topics such as ‘Moonshine’ through the relationship “Charge”. It should be noted that the titles of such relationships can be changed to be more informative. In this case, for example, the Explore Topic ‘Charge’ could be replaced with ‘Charged with” for ‘Sam Giancana’ and with ‘People charged with” for ‘Moonshine’. The illustrated interface shows the directionality of the relationship. Under ‘Moonshine/Charge’, an arrow points at the OOTU Topic Sam Giancana to indicate that he was charged with the crime. Under ‘Sam Giancana/Charge’ the arrow points away to show that the Moonshine charge is an attribute of him, not the other way around.

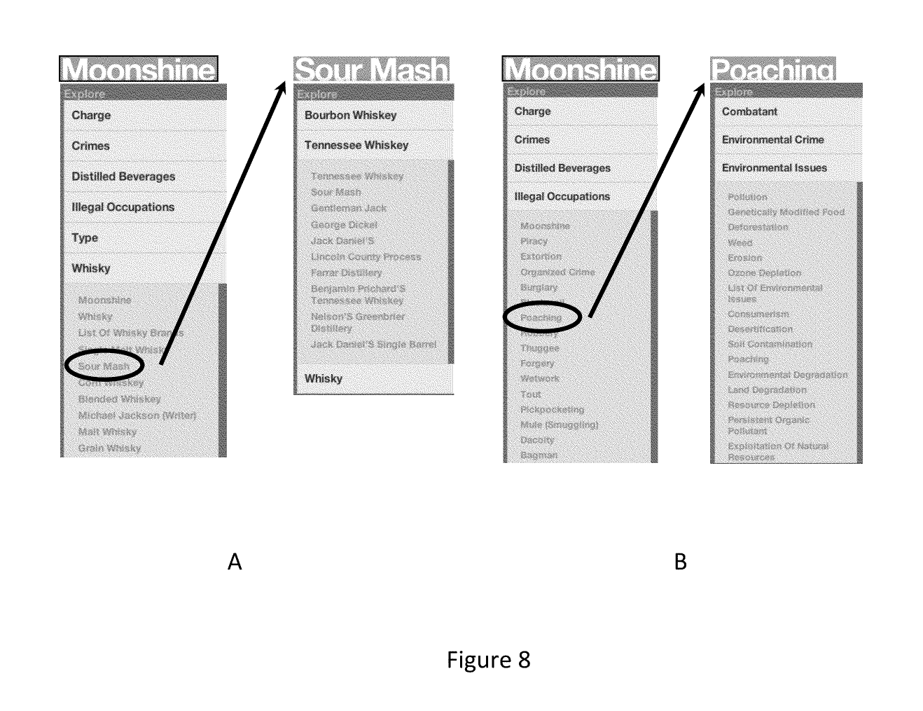

Because any particular topic can have many features, sequential selections can provide large numbers of alternative paths that, from an information perspective, are remarkably different. For example, FIG. 8, panel A, shows a pathway of OOTU Exploration that can be depicted as ‘Moonshine’>‘Whisky’>‘Sour Mash’>‘Tennessee Whiskey’ in which it is possible to discover things related to Tennessee Whiskey starting from Moonshine. However, Moonshine is also in a category of Illegal Occupations that includes the OOTU Topic ‘Poaching’. Following that pathway (FIG. 8, panel B) leads to the exploration of Poaching which, in turn, reveals other Environmental Issues from ‘Desertification’ to ‘Ethics of Terraforming’ (‘Moonshine’>‘Illegal Occupations’>‘Poaching’>‘Environmental Issues’. One pathway can be construed as narrowly focused on beverages. The other is very broadly concerned with illegal or anti-social activities and their societal effects. FIG. 8 shows two very different pathways of information exploration via OOTU Categories. One takes the route through the relationships defined by the Whisky category. The other takes the route through the relationships defined by the ‘Illegal Occupations’ category. This is schematically shown as follows: (1) Moonshine>Whisky>Sour Mash>Tennessee Whiskey; or (2) Moonshine>Illegal Occupations>Poaching>Environmental Issue.

Navigation of Topics and Categories via the OOTU menus is extremely valuable because topics and relationships are not known to an information seeker until he is familiar with the subject in question. There is a “chicken/egg” problem that keyword-based search solves only poorly. OOTU navigation menus allow an internet user to find an interesting topic to pursue and discover categories that represent zones of subject matter suitable for browsing. It is not so different from the way libraries provide a way to find reading matter by storing books of related content close to each other in the stacks. The electronic version of this is even more powerful, in that 1) the time taken to move between related topics is very, very short, and 2) related topics remain close to each other on the screen, even though they are connected to multiple other distinct topics. Unlike the physical world of the library, there is no need to categorize an OOTU Topic by only one catalogue number and a single set of proximal Topics.

Once found, the OOTU Topic of interest can be associated with a webpage or digital document as metadata, in effect tagging a URL or file location with one, or more, OOTU Topics. That digital content thus becomes semantically located by the user through the OOTU navigation menus, or discoverable by others who are using an interface connected to the OOTU API. Furthermore, the OOTU database and navigation menus can be used as a complementary tool to keyword search. Semantic exploration and discovery can provide a means to identify words that can be used in keyword-based search. As in the example above, one might not have thought a priori to do a search for a topic such as Chinese distilled beverages, but one's interest in Moonshine can provide the search term, Baijiu, in just two clicks thereby enabling the user to more deeply pursue an understanding of that beverage through conventional keyword-based search.

The OOTU API is a generally interesting tool for semantic exploration and discovery, allowing it to be applied to digital content of all types and applicable, in particular, to the goal of enhancing access to information stored in large databases that are available on public, private, or commercial websites. Based on user activity, the OOTU API can provide recommendation, filtering, or targeting of digital information. For example, a user might have watched a particular video on the website of an online network. The metadata associated with the video file could be used to obtain semantically-related videos that the viewer might enjoy. A similar use could serve the needs of an advertising network. A web page, newspaper article, digital image when associated with an OOTU Topic or Category, via the API, could lead to recommendations of related products. Alternatively, the recent history of a user's interaction with OOTU navigation menus could precisely reveal their current interests through the collection of semantically-related Topics associated with their path choices. In fact, it is likely that people's interests will be revealed quite quickly and make them demographically recognizable, even during a single session.

A specific recommendation use case could start with a search for a video in which the Indian actress Katrina Kaif appears. At a video-serving site, the search “katrina kaif” might offer options to look at “Katrina follows Ranbir's footsteps”, “Ranbir And Katrina The New Couple In Town”, “Katrina Refuses To Kiss Hrithik”, “Katrina Kaif—Journey Of Top 10 Bollywood Actresses”, “Katrina Playful Ad For Slice”, and others like this. Notably, all of these videos are found using the actress's name as a keyword. However, it would not be surprising if the user entering this search would be interested not only in Katrina Kaif videos, but also in videos that are relevant to actresses that were like Katrina Kaif. This limits the business opportunities of the video-serving site. Using the OOTU API, the user could be given other ideas for actors that he might find interesting. OOTU has an algorithm that is capable of drawing from the “semantic region” of Katrina Kaif in a database. There is no absolute definition of semantic region and an algorithm can be tuned to produce the most interesting results to the information provider. Using an algorithm that returns OOTU Topics directly connected to the OOTU Topic “Katrina Kaif” by any relationship but rejecting OOTU Topics that are in common categories as “Katrina Kaif”, then sorts them by popularity, and limited to 15 items, the following list is obtained (annotations in parentheses):

List of Bollywood films of 2013:

India

2013 in film

Yeh Jawaani Hai Deewani (a film starring Katrina Kaif)

France

Japan

China

Germany

London

Dubai

Hawaii

Netherlands

Switzerland

Shahrukh Khan (a Hindi film actor)

Salman Khan (a Hindi film actor)

England

Hong Kong

2012 in film

Indian Premier League

Africa

The returned topics can be filtered by other criteria. For example, since it is possible to make use of the association of OOTU Topics with ontological class terms, here is the list filtered to include People only, then sorted by popularity and limited to 15 items:

Shahrukh Khan

Salman Khan

Amitabh Bachchan (a Hindi film actor)

Ranbir Kapoor (a Hindi film actor and, apparently, her current boyfriend)

Aamir Khan (a Hindi film actor)

Vijay (actor)

Hrithik Roshan (a Hindi film actor)

Akshay Kumar

Anushka Sharma (a Hindi film actress and model)

Saif Ali Khan (a Hindi film actor)

John Abraham (actor) (a Hindi film actor)

Sonam Kapoor (a Hindi film actress)

Sunny Deol (a Hindi film actor)

Shilpa Shetty (a Hindi film actress)

Alternatively, the original Topics could be filtered to include only Films, then sorted by popularity and limited to 15 items:

Yeh Jawaani Hai Deewani

Bombay Talkies (film)

Jab Tak Hai Jaan

Dhoom 3

Vishwaroopam

Dabangg 2

Barfi!

Ek Tha Tiger

Kochadaiyaan

Zindagi Na Milegi Dobara

Agneepath (2012 film)

Hitch (film)

Bodyguard (2011 Hindi film).

Alternatively, an algorithm could be generated that returned members of categories to which Katrina Kaif belongs in the OOTU database. For example, this list from the category “Hindi Film Actors” sorted by popularity and limited to 15 items is:

Kareena Kapoor

Katrina Kaif

Shahrukh Khan

Salman Khan

Saif Ali Khan

Aamir Khan

Priyanka Chopra

Akshay Kumar

Amitabh Bachchan

Anushka Sharma

Sridevi

Rani Mukerji

Vidya Balan

Hrithik Roshan

Kajal Aggarwal.

Or one that returns members of the category “Non-Malayi Actors Acted in Malayali-Language Films” sorted by popularity and limited to 15 items is:

Katrina Kaif

Sridevi

Vidya Balan

Rajinikanth

Kamal Haasan

Tabu (Actress)

Juhi Chawla

Shriya Saran

Silk Smitha

Jyothika

Prabhu Deva

Priyamani

Prakash Raj

Jiiva

Madhavan.

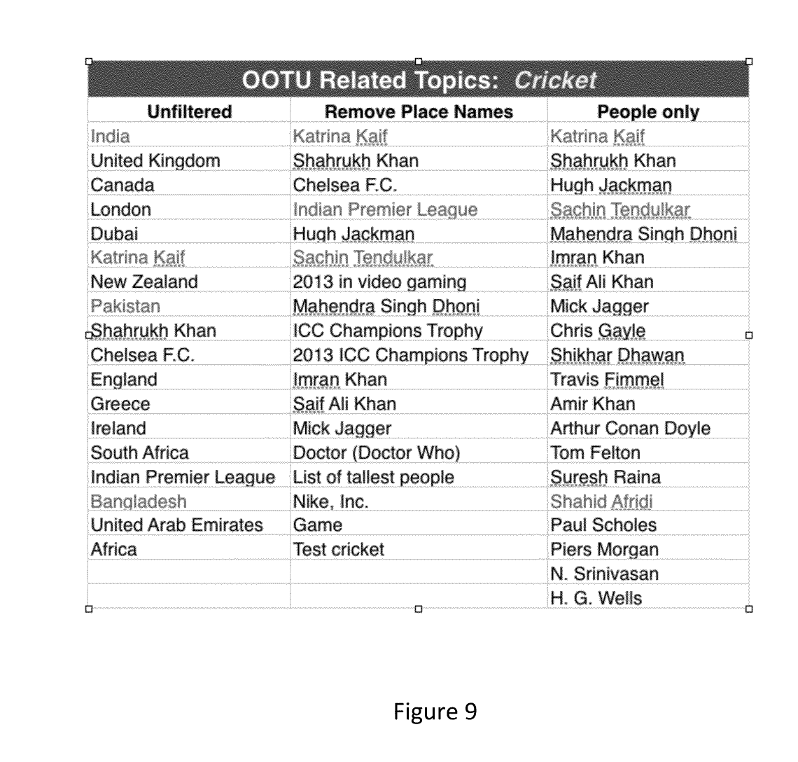

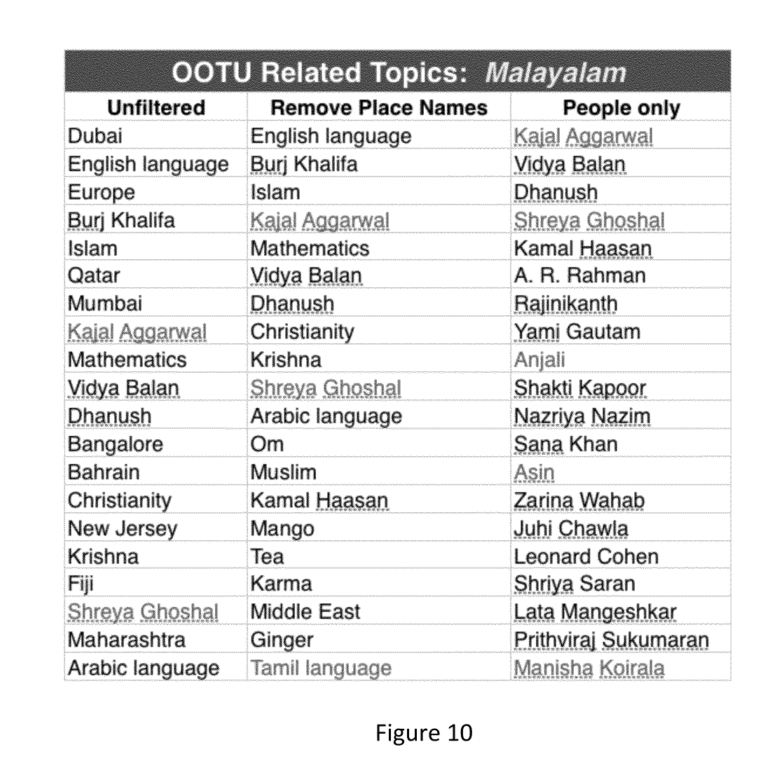

With many useful alternatives, one can employ conventional analytic techniques to learn which filter is the most useful for a given type of search for a particular population of users. Two other examples are shown in FIGS. 9 and 10, for the search Topic “cricket” and “Malayalam”.

In addition to applications in interne searching, there are a wide variety of other applications to the semantic searching aspects of the invention. For example, semantically tagged document databases, may be more readily searched without having to rely upon the informational specific content of the documents themselves. This allows accessing the content of the document database based upon a broader relational context of the documents contained therein. For example, one could access whole categories of documents that might be useful in a given project, but which would not be identified using a standard word search based upon the desired project. For example, in a database of documents at a law firm, one may be able to search sample OEM agreements based upon client name, or by searching for key words within those agreements. Given the lack of differentiability based upon key words, however, this type of searching would be less than ideal. By including semantic tagging, one could search based upon agreement type, particularly unique clauses, technology or product types, or any of a myriad of other relational characteristics.

4. Other Applications

In still other aspects, an inter-relational semantic tagging may be used based upon shared topics of smaller user groups, rather than being based upon a more broadly applicable ontology. Such smaller groups may include companies, social groups, families, or the like. As a result a smaller universe of interrelated topics, coordinated by the shared interest of the group, may be created, searched and accessed.

### V. Relevant User Targeting

A. Generally

In addition to providing the user or searcher with richer information based upon their search, the systems and tools of the invention also provide an opportunity for content providers to provide more meaningful information to users, based upon the contextual information of their searches. This could be in the context of institutions providing better guidance in response to user entered inquiries, and/or advertisers providing more relevant or connected products and services.

1. Contextual Relevance of Advertising

In certain aspects, the systems and tools of the invention may be used in the context of providing additional dimensions for content providers to target their desired or relevant audiences. By way of example, advertisers may be able to provide more meaningful targeting of advertising to potential customers based upon a more semantically accurate search outcome by the potential customer. In particular, an advertiser may be able to target advertising based upon a more semantic profile of the searcher's query. For example, by providing advertising content that is semantically tagged, advertisers would subject their content to the same semantic searching process of other content. By way of example, semantic relationships identified using the application of the invention may be used to identify AdWord choices, for use by advertisers to target sets of consumers. For example, a searcher looking at ‘Global Warming’, by virtue of their interest in that topic also may be more highly interested in ecological or environmentally friendly products, such as ‘Plug-in Electric Vehicles’, photovoltaic systems, and home wind power systems. As will be appreciated, the connection is not readily derivable from a straight key-word association to content, which would typically associate the searcher with different global warming related content, as opposed to content that is multiple relational nodes separated from the original content. As will also be appreciated, the ability to identify these associations provides a basis for designing an advertising campaign on the internet, e.g., a Google AdWord ad campaign.

In the context of the processes and systems described herein, an advertisement or collection of advertisements would be associated with the same semantic links as other content or subjects of interest in the database. As used herein, the term “advertisement” refers to any of a variety of commercial content, including commercial web pages, advertising content, e.g., specific ads, testimonial web pages, or the like, links to any of the foregoing. Upon a search query, these same relationships would be used to associate an advertisement or set of advertising campaign content, also stored within the database, with the subjects of interest that are returned, effectively presenting targeted advertising that is more contextually related to the original search.

In another example, the interrelated nature of the semantically tagged database may be exploited to present related topics to a consumer looking to make a particular type of purchase. For example, a person searching ‘Toyota Corolla’ could be interested in other cars that share attributes of the Corolla. Explore Topics for ‘Toyota Corolla’ include ‘Front-Wheel-Drive Vehicles’, ‘Compact Cars’, or ‘Sport Compact Cars’. In ‘Compact Cars’ will be found ‘Honda Civic’, ‘Subaru Impreza’, ‘Audi A3’. These manufacturers might want to take an ad when Toyota Corolla is searched. Or you could offer someone who searched ‘Prosciutto’ an ad for ‘Bayonne Ham’, a French preparation of dried pork.

Further, users too may be provided with a semantic signature or profile based upon their past searching history. This profile may be used to target that user with other content or topics for exploration, advertising, or the like. For example, a user who searches swimming products, cycling products and running shoes may be provided with a profile that would be used to target that user for upcoming triathlon events and products, as well as protein and other dietary supplements for endurance athletes.

2. Adjustable Relevance

In the context of more dimensioned audience targeting, the tools of the invention may also allow for the content providers to target their advertising or other targeting either more narrowly or more broadly, depending upon the particular needs of the content provider and the desired audience reach.

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above can be used in various combinations. All publications, patents, patent applications, and/or other documents cited in this application are incorporated by reference in their entirety for all purposes to the same extent as if each individual publication, patent, patent application, and/or other document were individually and separately indicated to be incorporated by reference for all purposes.

What is claimed is:

1. A computer implemented information search system, comprising:
a semantic database comprising a plurality of subjects of interest, each subject of interest being associated with one or more pieces of content of the database, and being related to at least one other subject of interest by one or more semantic tags; and
a computer search system coupled to the information database, the search system being programmed to access, identify and display a plurality of related categories based upon a user input search query each of the categories being linked to one or more subjects of interest that share a category defining feature.

2. The system of claim 1, wherein each of the subjects of interest is linked to one or more pieces of content within the semantic database or a different database, that share a subject of interest defining feature.

3. The system of claim 1, wherein the search system displays a plurality of first subjects of interest in response to a search query, the plurality of subjects of interest displayed are each related to each other by one or more semantic tags.

4. The system of claim 1, wherein the search system displays a plurality of second subjects of interest in response to selection of a first subject of interest, the second subjects of interest being related to each other and to the first subject of interest selected by one or more semantic tags.

5. The system of claim 4, wherein one or more of the second subjects of interest displayed comprises an advertisement related to one or more of the first and second subjects of interest by one or more semantic tags.

6. A computer implemented process for exploring one or more information databases, comprising inputting a search query into a computer search system that is coupled to a first semantic database, the first semantic database comprising a plurality of subjects of interest, each subject of interest being related to at least one other subject of interest by one or more semantic tags, wherein in response to the search query, the computer search system displays a plurality of categories, each of the categories being linked to one or more subjects of interest that share a category defining feature with each other.

7. The process of claim 6, wherein selecting a category displays a first plurality of subjects of interest linked to the category selected by one or more semantic tags.

8. The process of claim 7, wherein selecting a subject of interest from the first plurality of subjects of interest displays a second plurality of subjects of interest, the second plurality of subjects of interest being linked to the selected subject of interest from the first plurality of subjects of interest by one or more semantic tags.

9. The process of claim 6, wherein selection of a subject of interest displays a link to one or more pieces of content that share a subject of interest defining feature for the subject of interest selected.

10. The process of claim 7, wherein at least one of the one or more pieces of content displayed comprises an advertisement that shares a subject of interest defining feature of the subject of interest selected.

11. A computer user interface, the user interface displaying a plurality of information categories, each category defining a plurality of subjects of interest contained within a semantic database, wherein each of the plurality of subjects of interest in each category shares a category defining feature.

12. The computer user interface of claim 11, wherein selection of a displayed category displays the plurality of subjects of interest defined by the category selected.

13. The computer user interface of claim 12, wherein selection of a displayed subject of interest displays one or more links to one or more pieces of content within the semantic database or another database coupled to the computer user interface.

14. A computer implemented information access process, comprising:
providing a first database of subjects of interest, each subject of interest being linked to one or more pieces of content within the database by one or more semantic tags;
comparing a search query term to the first database;
identifying subjects of interest in the first database linked to the search query term by one or more semantic tags; and
presenting the subjects of interest of the first database identified in the identifying step.

15. The system of claim 14, wherein selection of a subject of interest displays a link to one or more pieces of content linked to the subject of interest by one or more semantic tags.

16. The system of claim 14, wherein selection of a subject of interest displays a link to one or more second subjects of interest, each of the second subjects of interest is linked to the selected subject of interest by one or more semantic tags.

17. The system of claim 15, wherein at least one of the one or more pieces of content comprises an advertisement, the advertisement being linked to the selected subject of interest by one or more semantic tags.
